(19) United States
(12) Patent Application Publication
(10) Pub. No.: US 2008/0301045 A1
(43) Pub. Date: Dec. 4, 2008

(54) SYSTEM AND METHOD FOR FACILITATING ENGAGEMENT AND COMMUNICATION BETWEEN A COMPANY AND A RECRUITING FIRM

(76) Inventors: Jeremy Lappin, New York City, NY (US); Christopher Benskey, San Francisco, CA (US); Mark Hohmann, San Francisco, CA (US); Jerry Aubin, Austin, TX (US)

Correspondence Address: SCHOX PLC, 730 Florida Street #2, San Francisco, CA, 94110, US

(21) Appl. No.: 12/125,005

(22) Filed: May 21, 2008

Related U.S. Application Data
(60) Provisional application No. 60/939,260, filed on May 21, 2007.
(60) Provisional application No. 60/948,244, filed on Jul. 6, 2007.
(60) Provisional application No. 60/971,102, filed on Sep. 10, 2007.
(60) Provisional application No. 60/971,106, filed on Sep. 10, 2007.
(60) Provisional application No. 60/971,109, filed on Sep. 10, 2007.
(60) Provisional application No. 60/971,112, filed on Sep. 10, 2007.
(60) Provisional application No. 60/971,126, filed on Sep. 10, 2007.
(60) Provisional application No. 60/971,128, filed on Sep. 10, 2007.
(60) Provisional application No. 60/971,131, filed on Sep. 10, 2007.
(60) Provisional application No. 60/977,563, filed on Oct. 4, 2007.

(51) Int. Cl. G06Q 10/00; G06Q 20/00

(52) U.S. Cl. 705/39; 705/1

(57) ABSTRACT

A system to facilitate engagement and communication between a company with an available position and at least one recruiter includes a server coupled to a computer network, a user interface for co-workers at the company coupled to the server over the computer network and a plurality of co-workers post information to the server about an available position of the company, including a bounty, receive information from the server about candidates for the available position of the company, and select a candidate on the server for the available position, and a user interface for recruiters coupled to the server over the computer network and a plurality of recruiters receive information from the server about an available position of the company and submit information to the server about a candidate for the position of the company.

### CROSS-REFERENCE TO RELATED APPLICATIONS

This application claims the benefit of U.S. Provisional Application No. 60/939,260, filed May 21, 2007 and entitles “Method to Facilitate Engagement and Communication Between an Enterprise and a Recruiter”, the benefit of U.S. Provisional Application No. 60/948,244, filed Jul. 6, 2007 entitles “Method to Facilitate Engagement and Communication Between a Company and a Recruiting Firm”, the benefit of U.S. Provisional Application No. 60/971,102 filed Sep. 10, 2007 and entitled “Method to Facilitate Engagement and Communication between a Company and a Recruiter: Status Updates”, the benefit of U.S. Provisional Application No. 60/971,106 filed Sep. 10, 2007 and entitled “Method to Facilitate Engagement and Communication between a Company and a Recruiter: Hiring Deadline”, the benefit of U.S. Provisional Application No. 60/971,109 filed Sep. 10, 2007 and entitled “Method to Facilitate Engagement and Communication between a Company and a Recruiter: Propose Bounty”, the benefit of U.S. Provisional Application No. 60/971,112 filed Sep. 10, 2007 and entitled “Method to Facilitate Engagement and Communication between a Company and a Recruiter: Standing Bounty”, the benefit of U.S. Provisional Application No. 60/971,126 filed Sep. 10, 2007 and entitled “Method to Facilitate Engagement and Communication between a Company and a Recruiter: Messaging”, the benefit of U.S. Provisional Application No. 60/971,128 filed Sep. 10, 2007 and entitled “Method to Facilitate Engagement and Communication between a Company and a Recruiter: Pending Engagements”, the benefit of U.S. Provisional Application No. 60/971,131 filed Sep. 10, 2007 and entitled “Method to Facilitate Engagement and Communication between a Company and a Recruiter: Feedback”, and the benefit of U.S. Provisional Application No. 60/977,563 filed Oct. 4, 2007 and entitled “Method to Facilitate Engagement and Communication between a Company and a Recruiter: Sorting by Login.” All ten US Provisional Applications are incorporated in their entirety by this reference.

### TECHNICAL FIELD

This invention relates generally to the e-commerce field, and more specifically to an improved system and method for facilitating engagement and communication between an enterprise with multiple available positions and multiple recruiters in the e-commerce field.

### BACKGROUND

With the increasing mobility and sophistication of the modern labor force, companies often need to quickly fill an available position. Because of the depth and breadth of the expertise of most companies, it is impractical for them to engage candidates directly through a centralized human resources department. As such, many companies utilize one or more recruiters for the purpose of finding appropriate candidates for the required positions.

An unfortunate result of the use of recruiters is that companies are often inundated with information about candidates that are not qualified for one reason or another. Moreover, companies are often forced to deal with inexperienced or otherwise undesirable recruiters that do not have the appropriate skills for attracting the necessary talent. As a result, the combination of unqualified candidates and inefficient or inexperienced candidates forces companies to invest substantial time and resources in the evaluation and eventual rejection of prospective candidates. Ironically, the proliferation of inexperienced recruiters submitting the information of unqualified candidates places such a significant burden on the companies that for all practical purposes, they might be just as well served to perform their recruiting through their own firm. Thus, there is a need in the e-commerce field to create an improved system and method for facilitating engagement and communication between an enterprise with multiple available positions and multiple recruiters in the e-commerce field.

### BRIEF DESCRIPTION OF THE FIGURES

FIG. 1 is a schematic diagram illustrating the elements involved in the system of the preferred embodiment of the invention.

FIGS. 2-3 are schematic diagrams illustrating the parties involved in the system and method of the preferred embodiment.

FIGS. 4-5 are flowcharts illustrating the steps of a first and second enterprise method, respectively of a preferred embodiment of the invention.

FIGS. 6-14 are screen shots depicting a user interface and a networked computer in accordance with alternative embodiments of the present invention.

FIGS. 15 and 16 are schematic diagrams illustrating the parties involved in the individual version and the first enterprise version, respectively.

FIGS. 17-21 are screen shots depicting a user interface and a networked computer in accordance with the first enterprise version of the present invention.

FIGS. 22-23 are screen shots depicting a user interface and a networked computer in accordance with the second enterprise version of the present invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1 The Enterprise System

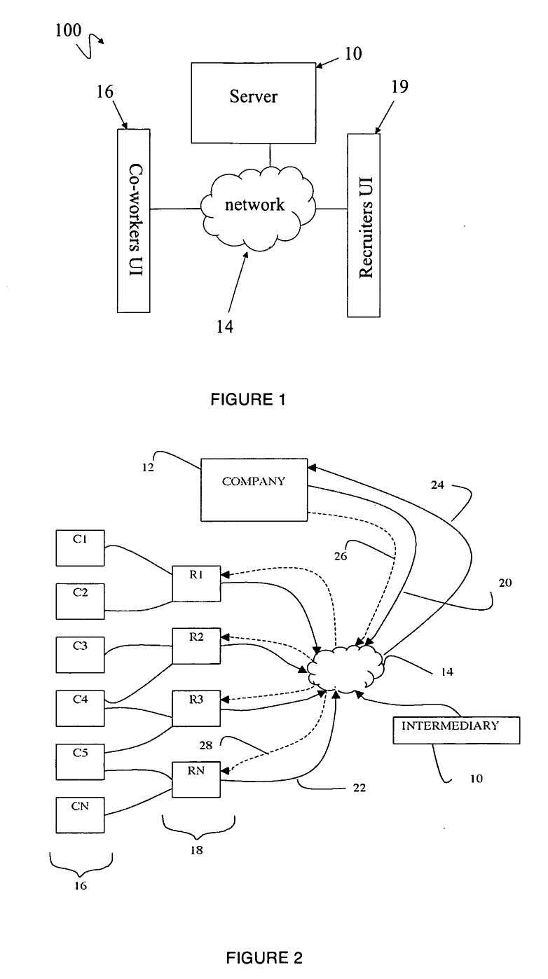

As shown in FIG. 1, a system 100 to facilitate engagement and communication between a company with an available position and at least one recruiter includes a server 10 coupled to a computer network 14, a user interface for co-workers 16 at the company coupled to the server over the computer network 14, and a user interface for recruiters 19 coupled to the server 10 over the computer network 14. The system enables collaboration between co-workers in HR departments dealing with individual recruiters as well as recruiting firms. As used herein, the term “company” refers to an entity or natural person that is engaged in a business. The term “available position” refers to any opportunity for a relationship between the company and any natural person or entity (a “candidate”). The term “relationship” includes, for example, an employment agreement, a service agreement, or any other contractual arrangement involving payment by the company to the candidate for due consideration according to the relationship. The term “recruiter” refers to any natural person or entity that engages, on a limited or exclusive basis, in the business of facilitating the entry of a candidate and a company into a relationship. An “active recruiter” refers to a recruiter who is actively working in any capacity on filling an available position of a company. The term “bounty” is a payment or reward, preferably in the form of a monetary transaction, from the company to the recruiter for the acceptance of a submitted candidate.

The user interface for co-workers 16 of a company functions to allow a plurality of co-workers to post information to the server about an available position of the company, including a bounty, receive information from the server about candidates for the available position of the company, and select a candidate on the server for the available position. The user interface for co-workers 16 may also function to allow at least one user working for a company to add notes about recruiters or candidates that are shared among some or all of the co-workers of that company. The user interface is preferably a web-browser on a computer that is connected to or connectable to the computer network 14, such as a server, personal computer, personal digital assistant, mobile phone, or any other combination of hardware and/or software that is adapted to perform machine executable instructions according to the method of the preferred embodiment. In one alternative embodiment, the user interface is a rich Internet application (Such as an Adobe AIR runtime application) on a computer connected to or connectable to the computer network 14. Preferably, the user interface for co-workers of a company includes a news feed. The news feed functions to capture the recent hiring activity of co-workers and enable collaboration between at least one team of co-workers within the company. The news feed is preferably visible to all co-workers working at a company, but may alternatively be viewable by a subset of co-workers working at a recruiting firm if administrative privileges are set by the company administrator (such as engineering job activities are only viewable by the engineering hiring team). The company administrator may also indicate which of their activities are visible to the recruiters.

The user interface for recruiters 19 preferably functions to enable recruiters to receive information about a candidate for the available position of the company from the recruiter, and submit information about a candidate for the available position to the company on or though any computer that is connected or connectable to the network 14 as described above. The user interface for recruiters 19 may also function to enable at least one recruiter working for a recruitment firm to add notes for their recruiter team members, about a company or a candidate for a particular company. Preferably, the user interface for recruiters in a recruiting firm includes a news feed. The news feed functions to capture the recent recruiting activity of recruiters and enable collaboration between at least one team of recruiters within the recruiting firm. The news feed is preferably visible to all recruiters working at a recruiting firm, but may alternatively be viewable by a subset of recruiters working at a recruiting firm if administrative privileges are set by the recruiting administrator (such as engineering job activities are only viewable by the engineering recruitment team). The recruiters may also indicate which of their activities are visible to the company.

The server 10 functions to store and transmit data from each user interface. More specifically, the server functions to store and transmit assigned administrative privileges, posted information about an available position of a company, posted bounties for the available position of the company, submitted candidates for the available position of the candidate, and news feed information. The server preferably enforces administrative privileges of each user (whether co-worker at a company or recruiter at a recruiting firm). The server also preferably functions to facilitate the transmission of payment of a bounty (as described below). The server is preferably connected to or operatively connectable to each user interface over a computer network 14.

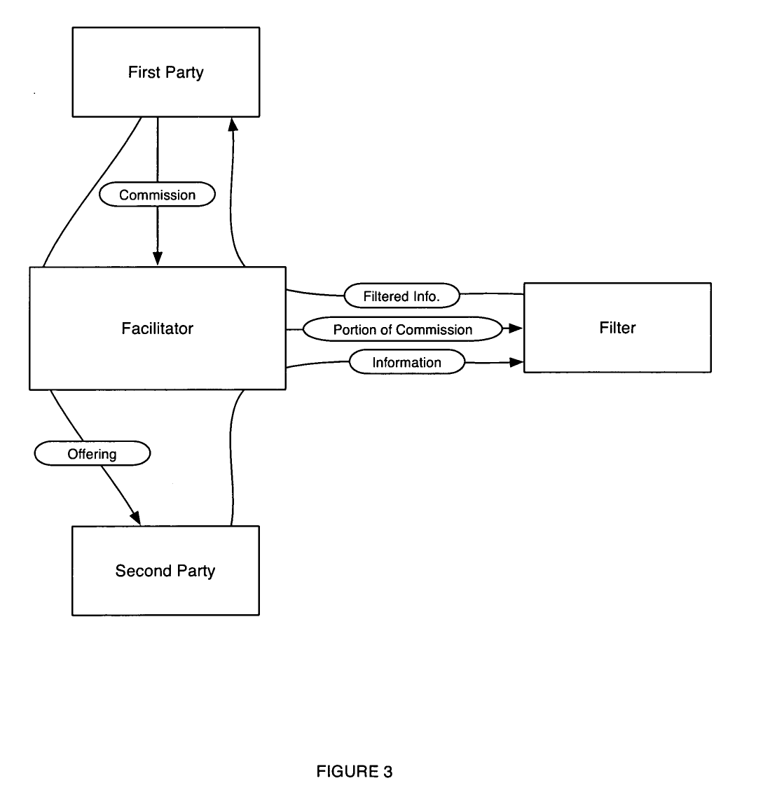

As shown in FIGS. 2 and 3, an intermediary 10, a company 12, a plurality of recruiters (R₁, R₂, R₃, and RN) 18 and a plurality of candidates (C₁, C₂, C₃, C₄, C₅ and CN) are operatively connectable, either through wired or wireless means, to a computer network 14. The computer network 14 functions to permit data communications between two or more parties, such as the company 12 and one or more of the plurality of recruiters 18, such that the company 12 and the one or more of the plurality of recruiters 18 need not be in direct, personal contact regarding the available position or any attribute thereof. Moreover, the computer network 14 functions to allow the company 12 to readily post information 20 about the available position to the plurality of recruiters 18 in a simultaneous, interactive, and widely disseminated manner. The computer network 14 further functions to permit the recruiters to submit information about a candidate 22 to the company 12, and for the company 12 to access one or more submissions 24. Lastly, the computer network 14 functions to facilitate the receipt of payment 26 from the company 12 and the transmitting of a portion of the payment 28 to a recruiter 18. The computer network 14 can include any two or more computers that are connectable directly or indirectly through a local or wide-network, including for example the Internet or World Wide Web. Each of the company and the plurality of recruiters can communicate through the computer network 14, for instance through a single website consisting of multiple web pages operated by an intermediary 10.

### 2 Enterprise Version Methods

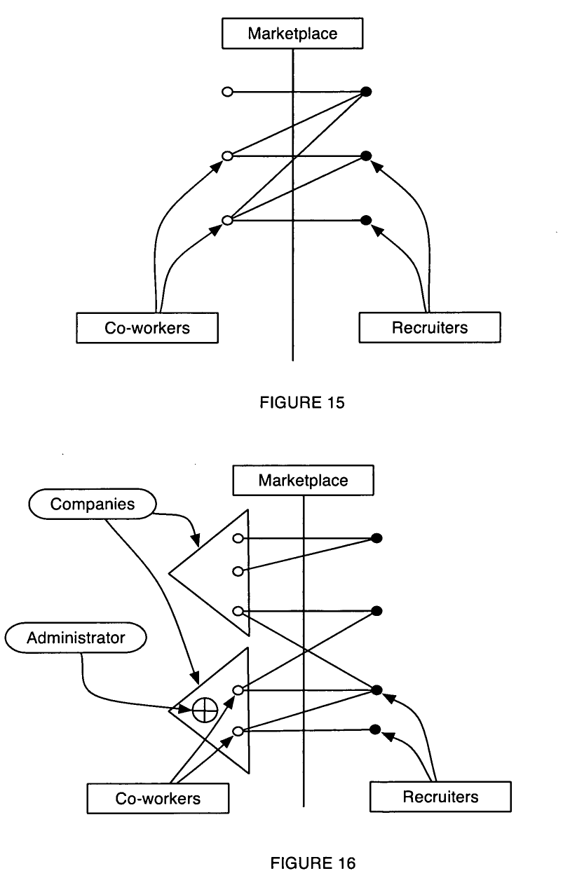

As shown in FIG. 15, the individual version of the preferred method of the invention includes a marketplace at the individual level (between a sole employee at a company and multiple recruiters). In contrast, the first enterprise version of the preferred method of the invention, as shown in FIG. 16, includes a marketplace at the enterprise level (between multiple employees working for the same company and multiple recruiters). The first enterprise version includes a collection of employees (sometimes referred to as “users” or “coworkers”) for a particular company. The first enterprise version preferably includes an administrator role that has special privileges and/or permissions, but this role (and the corresponding privileges and/or permissions) may alternatively be distributed to the employees. The second enterprise version of the preferred method of the invention, which is similar to the first enterprise version, includes a marketplace at the enterprise level (between one or more companies with available positions and several recruiters working for the same recruiting firm). The second enterprise version includes a collection of recruiters (sometimes referred to as “enterprise recruiters”) for a particular recruiting firm.

### 2.1 First Enterprise Version

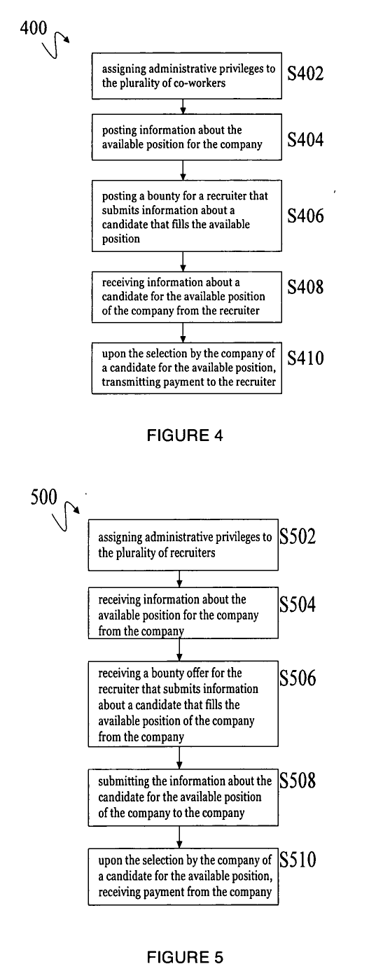

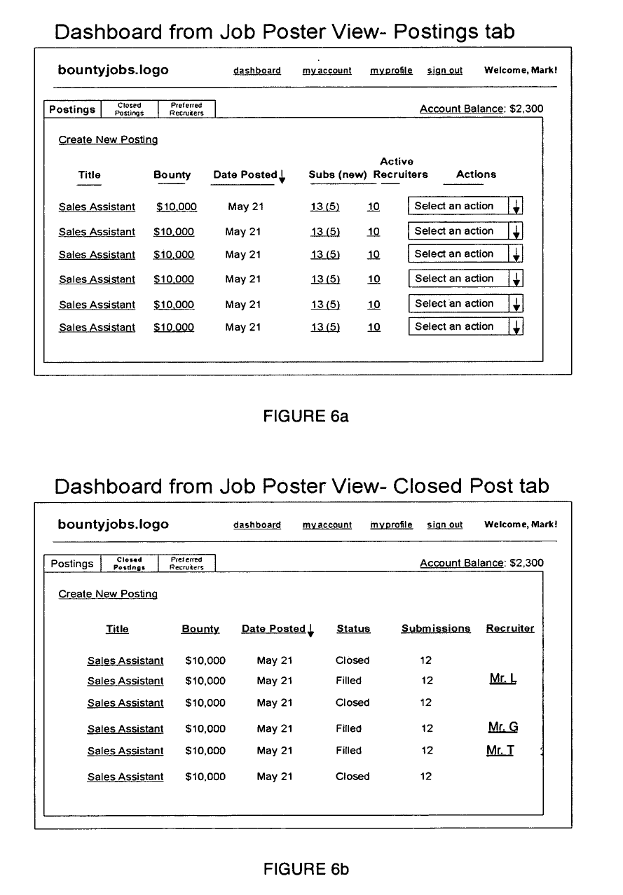

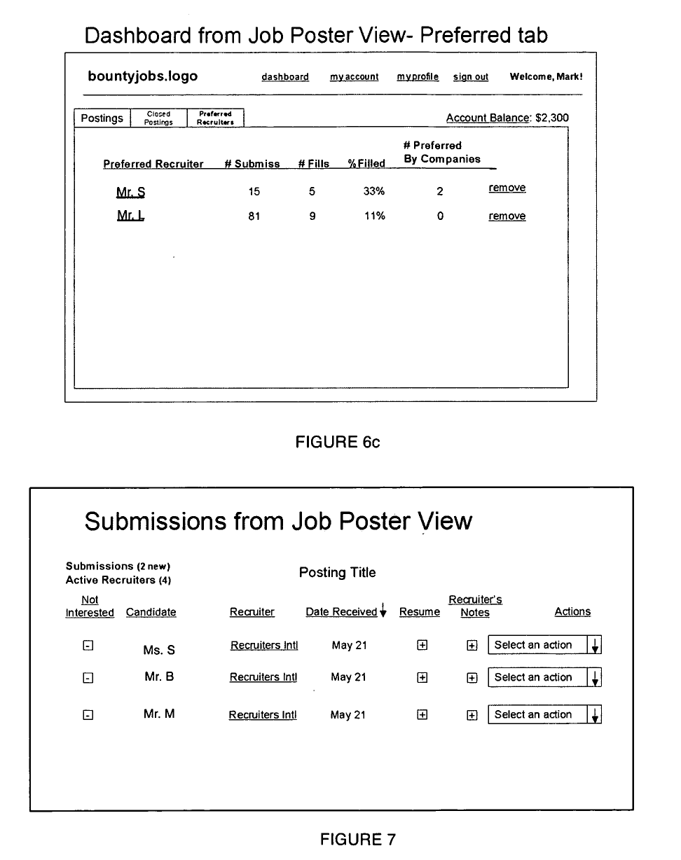

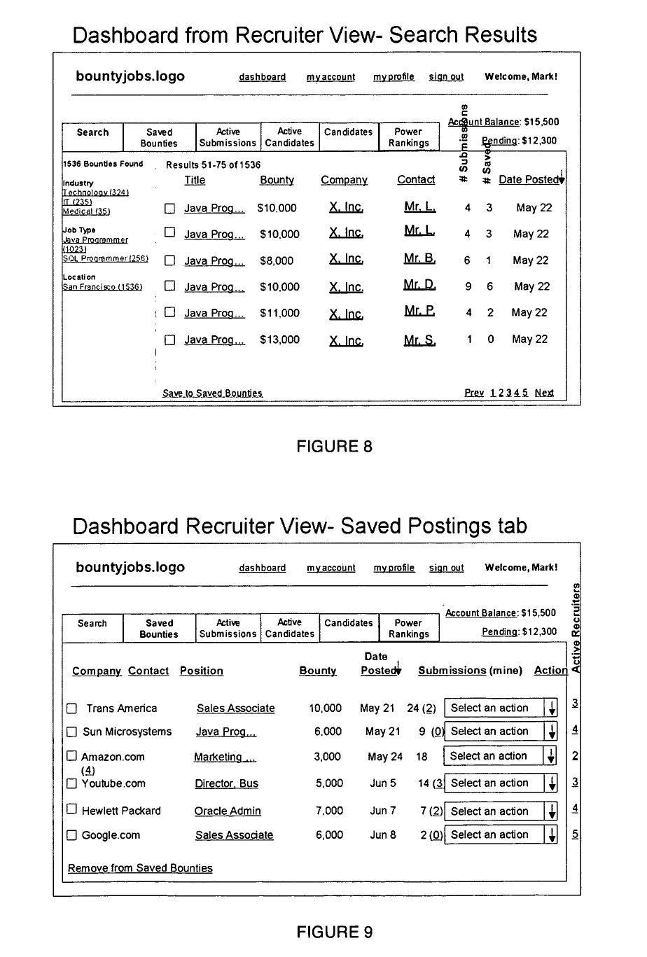

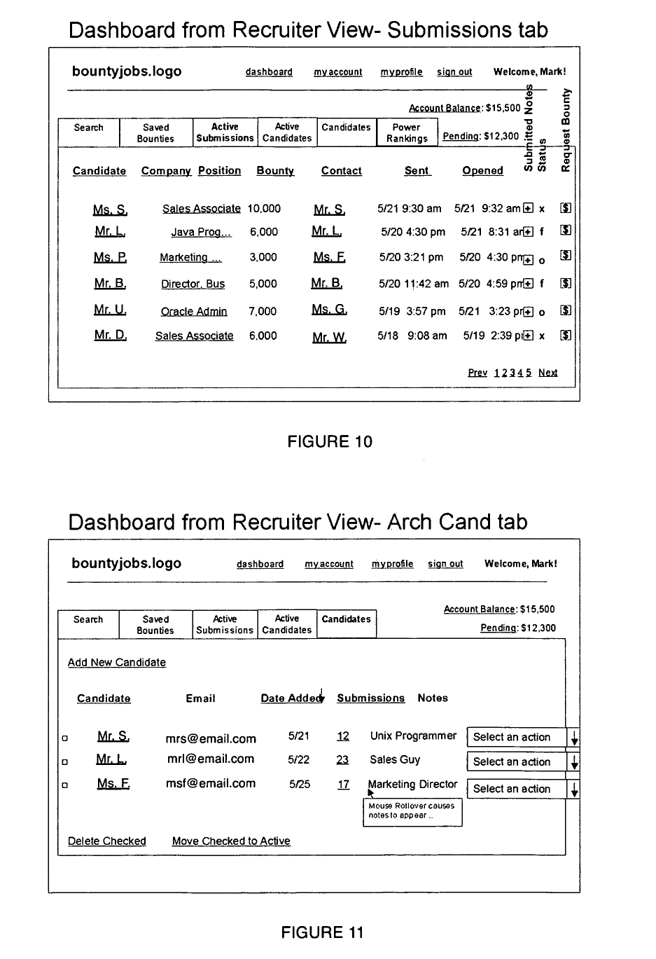

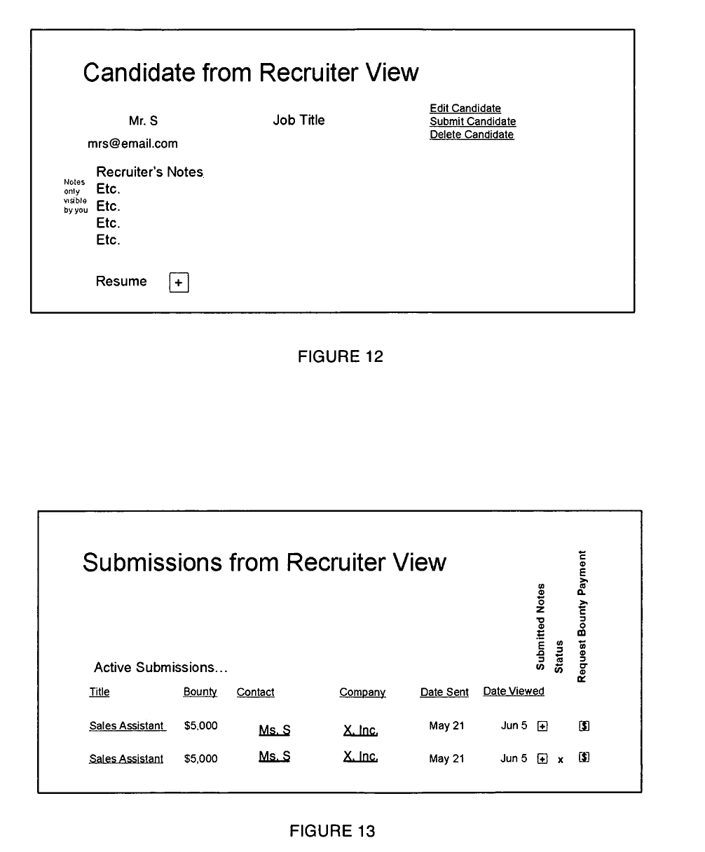

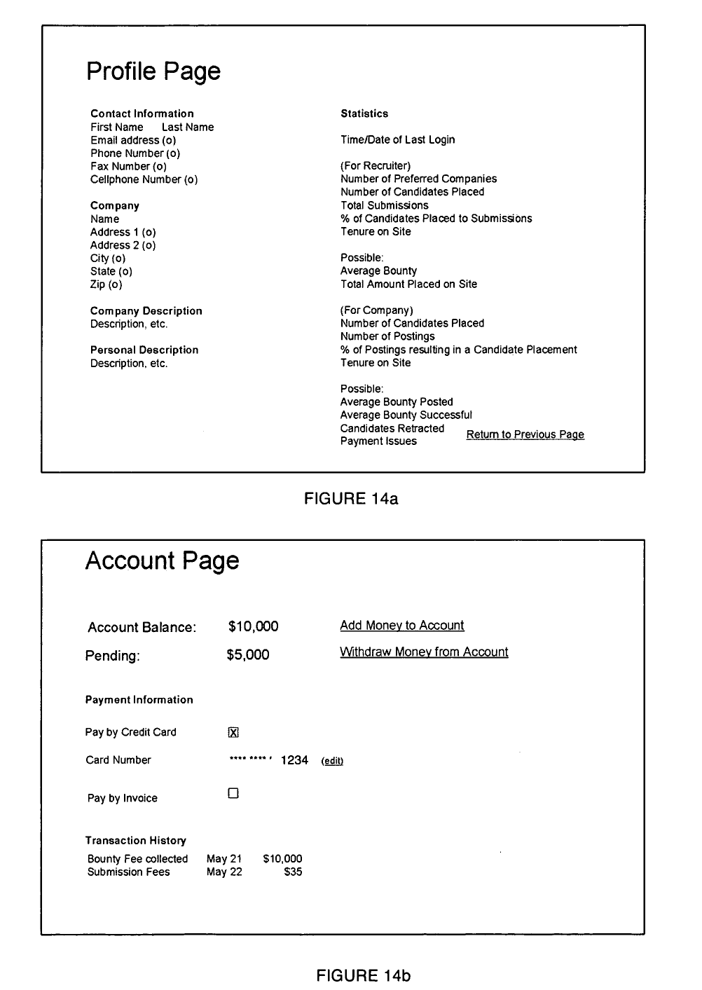

As shown in FIG. 4, a first method 400 of the preferred embodiment includes a series of steps to facilitate collaboration and communication between a plurality of co-workers of a company with an available position while interacting with a recruiter. The first method 400 preferably includes assigning administrative privileges to the plurality of co-workers S402, posting information about the available position for the company S404, posting a bounty for a recruiter that submits information about a candidate that fills the available position S406, receiving information about a candidate for the available position of the company from the recruiter S408, and upon the selection by the company of a candidate for the available position, transmitting payment to the recruiter S410.

Step S402, which recites assigning administrative privileges to the plurality of co-workers, functions to enable an administrator to add or delete users within the enterprise, assign particular privileges and permissions (also called administrative privileges) to co-workers (also known as users) at the company, such as assigning the task of filling available positions of the company to co-workers, adding new recruiters, blocking recruiters, engaging a recruiter, promoting a recruiter to a preferred recruiter, promoting a recruiter to an enterprise recruiter, and setting a range of bounty amounts for which a co-worker may authorize, assigning permission to generate a report on a recruiter, assigning permission to generate a report on a co-worker, assigning permission to access positions of the company, assigning permission to generate a report on a candidate for a position of the company, assigning permission to participate in the candidate hiring process, or assigning any suitable subset of the administrative privileges available to the company administrator.

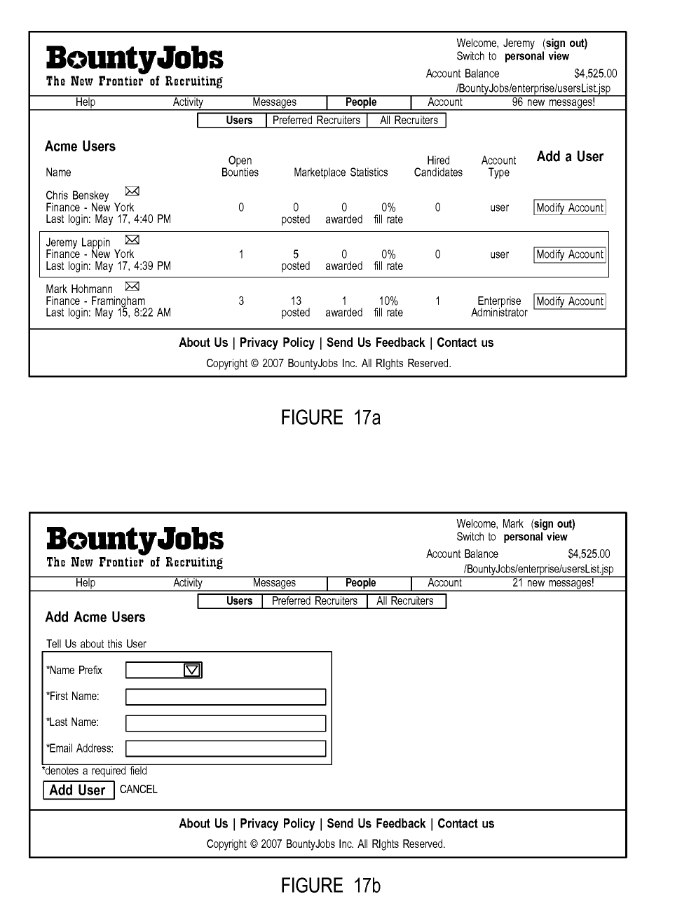

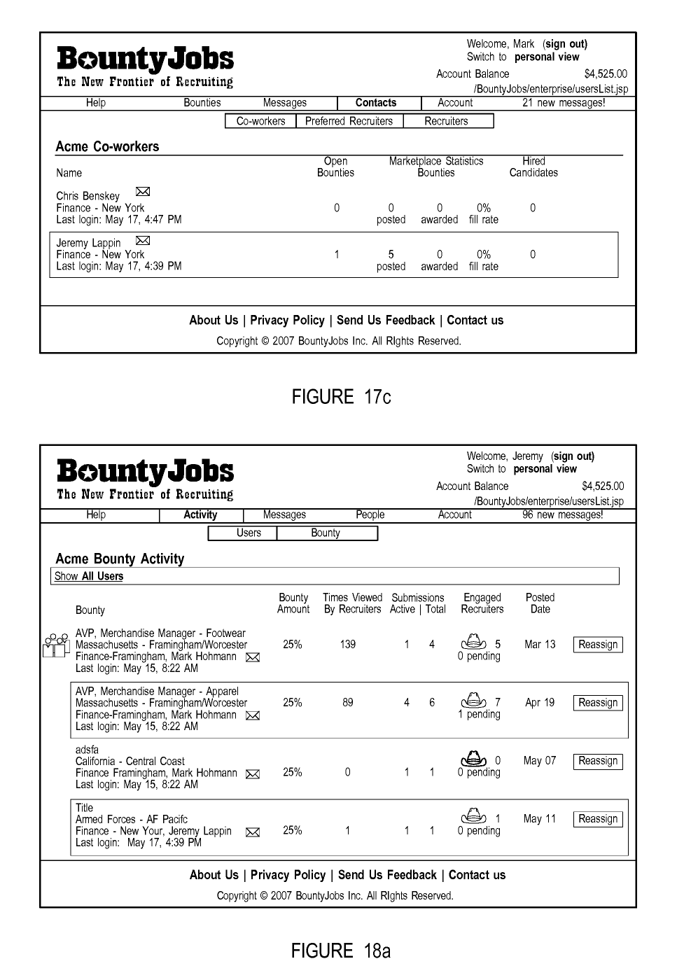

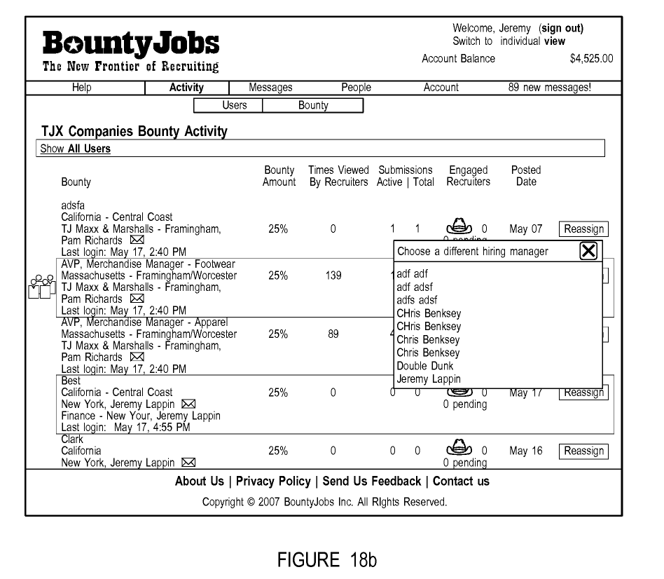

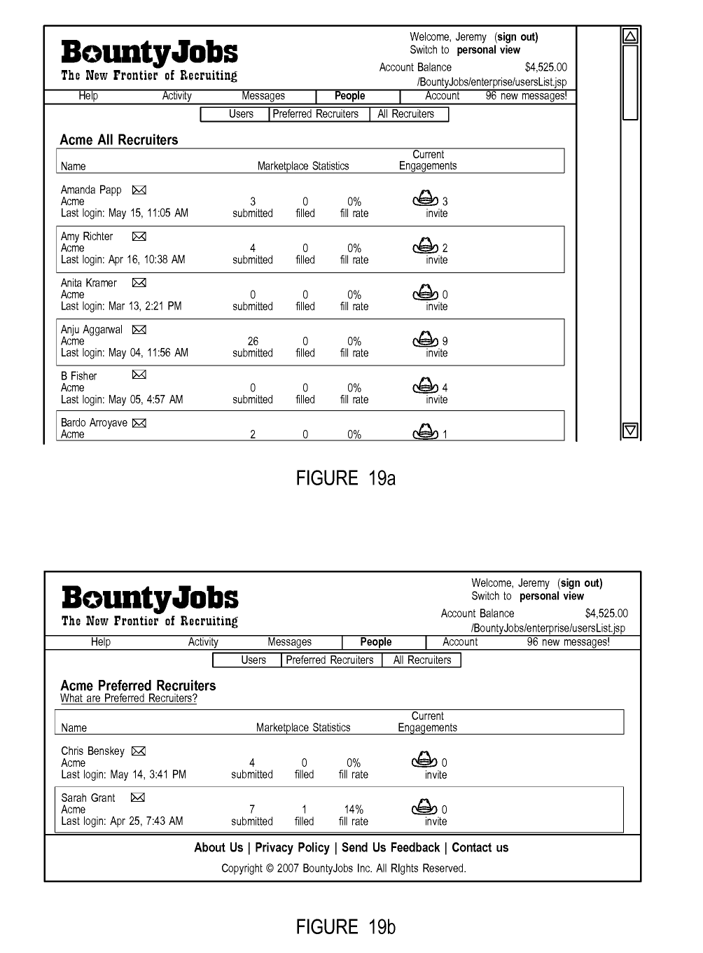

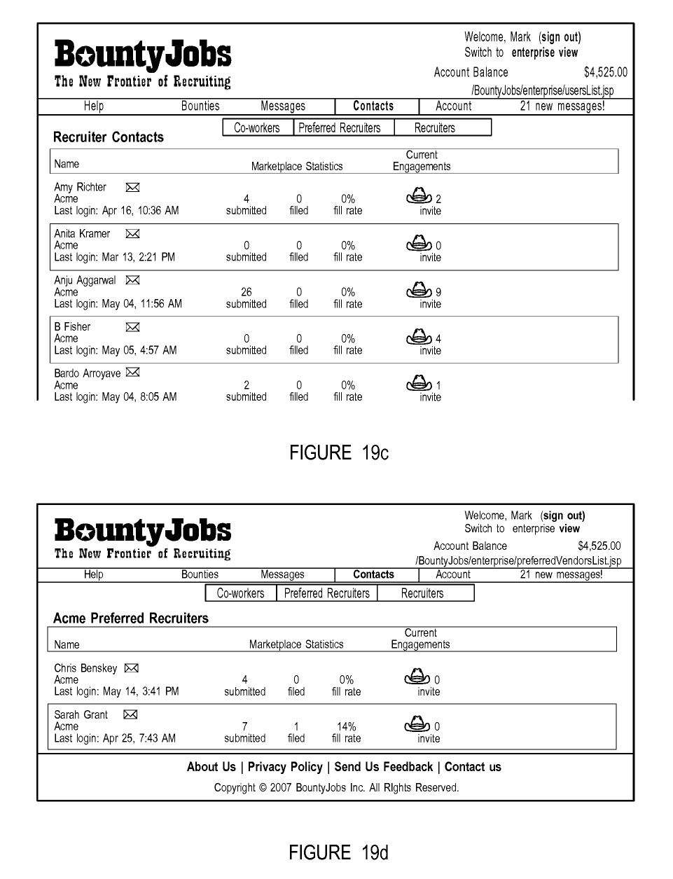

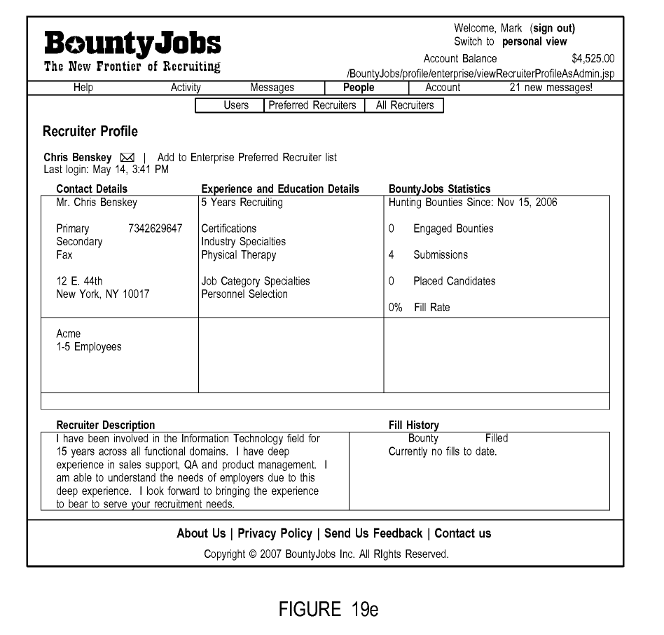

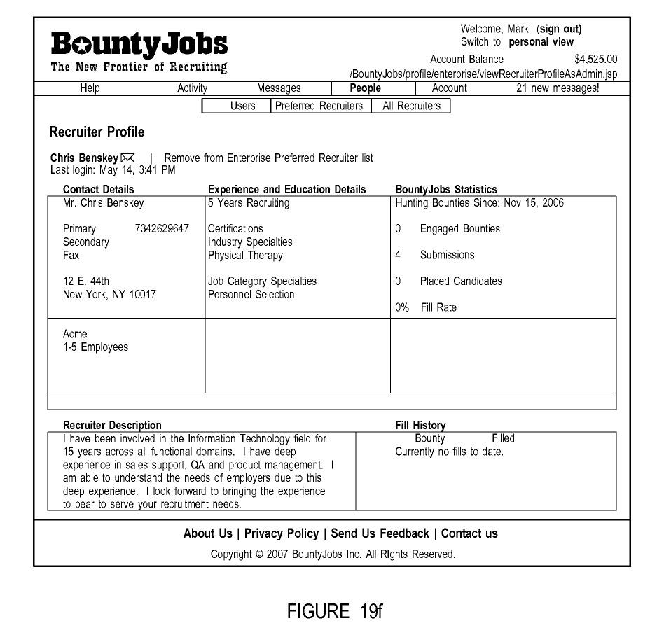

As shown in FIGS. 17A and 17B, the administrator may add and delete users within the enterprise and/or assign particular privileges and/or permissions to the users. This role may be reserved for a Human Resource Director (or equivalent) within the company. The co-workers can be viewed and easily contacted by other users within the enterprise, as shown in FIG. 17C. As shown in FIGS. 18A and 18B, another privilege of the administrator includes re-assigning a bounty from one co-worker to another co-worker. This privilege may be useful to re-distribute the workload amongst co-workers, to reward (or penalize) a particular co-worker, to move the responsibility of the bounty and the candidate to another person within a Human Resource department, or for any other suitable reason. As shown in FIG. 19A, at the enterprise level, all of the recruiters that are preferred by a user within the enterprise can be viewed by the administrator. The administrator (or another co-worker with appropriate administrative privileges) may view a particular recruiter, as shown in FIG. 19E, and “promote” the recruiter to the status of an “enterprise preferred recruiter”, as shown in FIG. 19B. The administrator may also “demote” the enterprise preferred recruiter, as shown in FIG. 19F. The co-workers can selectively view their own preferred recruiters, as shown in FIG. 19C, and may view the enterprise preferred recruiters, as shown in FIG. 19D.

In the preferred embodiment, Step S402 includes setting administrative privileges for a news feed of co-worker activity. The news feed functions to capture the recent hiring activity of co-workers and enable collaboration between at least one team of co-workers within the company. The news feed is preferably visible to all co-workers working at a company, but may alternatively be viewable by a subset of co-workers working at a company if administrative privileges are set by the company administrator (such as engineering job activities are only viewable by the engineering hiring team). The company administrator may also indicate which of their activities are visible to the recruiters.

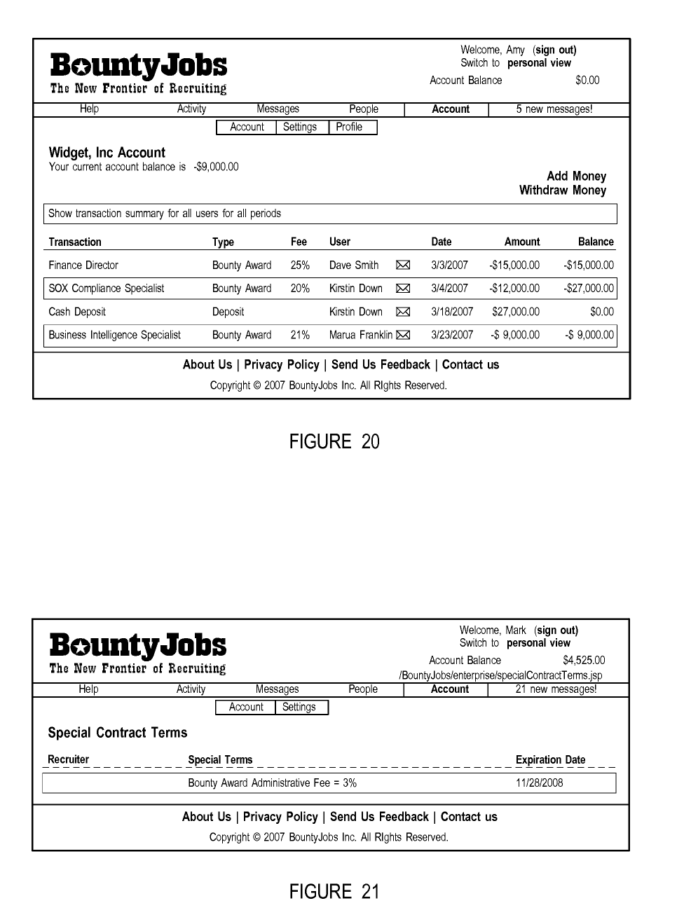

The administrator may also assign permission to access statistics of an enterprise. Permission may be assigned to co-workers within the company, or to external entities, such as recruiters or recruiting firms. As shown in FIG. 20, the statistics for the enterprise may be viewed, internally, on a user level or an enterprise level. In a similar manner, the statistics for the enterprise may be viewed, externally from the recruiters vantage point, on a user level or an enterprise level. This may allow the company to be regarded evaluated in a positive light (with strong statistics) even after a new recruiter (with weak statistics) has been recently added. In other words, the history in terms of the total available jobs and job placements of the company may be captured and viewed as a report.

The administrator may also have authority (or delegate/assign authority) over the contract terms for the bounty transaction between the company and the recruiter or recruiting firm. As shown in FIG. 21, the first enterprise version may allow for special contract terms for the bounty transaction between the company and the recruiter. These special contract terms may be used, for example, when the company wishes to use the first enterprise version with existing or previously contracted recruiters. In this case, the distribution (or “cut”) of the bounty may be changed to reflect the responsibilities of the parties.

Step S404, which recites posting information about the available position of the company, functions to post information about an available position, such that a recruiter may use the posted information to find a suitable candidate for the position of the company. The information about the available position can include any pertinent or requisite skills preferred or required for the available position as well as any background information about the company or the available position. Additionally, the information about the available position can include for example any necessary submissions by the candidate including any pertinent biographical or working history, including for example a resume, curriculum vitae, writing sample, salary requirements, salary history, employment history, employer references, background check information, professional or paraprofessional licenses, credit history, citizenship status, employment visa status, security clearances, and/or any additional information required for the available position. Additionally, the company administrator may post information about the available position for the company and the number of active recruiters for the available position. This permits a company see the number and identity of those active recruiters that are showing an increased level of interest in submitting candidate information for the available position. This also allows one or more recruiters to see the aggregate interest in, and hence the prospective competition for, a submission with respect to the available position. To the extent that there are a large number of active recruiters, the company can expect a proportionally large number of submissions of information about candidates. Conversely, if there are a small number of active recruiters, then the company may opt to modify the amount of the bounty as described above in order to attract more interest from those recruiters that are not currently listed as active recruiters.

Step S406, which recites posting a bounty for a recruiter that submits information about a candidate that fills the available position, functions to list a bounty amount to be rewarded to a recruiter for submitting a candidate that fills the available position. The posting of the bounty for the available position of the company functions to increase the incentives for any one or more recruiters to submit the information about a candidate to the company. The step of posting a bounty for the available position of the company can be performed by a co-worker of the company with administrative privileges allowing them to do so. The bounty can include for example a pecuniary award payable in exchange for a successful selection of a candidate for the available position. The bounty can be payable through any means, including cash, check, credit card payment, wire transfer and the like, and can be payable in any currency or denominations thereof. In one variation, the company may modify the amount of the bounty. Allowing the company to modify the bounty functions to permit the company to attract more or fewer potential recruiters, and thus more or fewer potential candidates for the available position. As expected according to general economic principles, if the company decreases the amount of the bounty, then fewer recruiters and thus fewer potential candidates will likely be interested in the available position. On the contrary, if the company increases the amount of the bounty, then more recruiters thus more potential candidates will likely be interested in the available position. Alternatively, the method can include the step of allowing the company to modify the amount of the bounty such that the company is allowed to increase, but not decrease, the amount of the bounty. This alternative functions to assure the recruiter at least a minimum value of a bounty, such that the recruiter is willing to invest the necessary time and energy in order to submit a candidate for the available position.

Another variation of step S406 may include proposing a new bounty for a job candidate. This variation may include modifying the bounty agreement, where both the recruiters and the company agree on the bounty in advance, if candidates are determined to be better suited for another job within the company. The other job in the company is preferably a job already posted, but may alternatively be a newly created job for a candidate, or a job not yet listed. In order to prevent the company from taking advantage of the recruiter, and proposing low bounties on candidates they will hire for other positions than the position the candidate was submitted for, it is preferable to have an initial bounty modification agreement in place. The recruiter, the company, or an independent third party preferably specifies the bounty modification agreement in advance. The bounty modification agreement preferably includes a percentage of the original bounty, for example 125% or 80% of the bounty of the original position, and is agreed upon by all parties before the candidate is submitted. The company, when evaluating a candidate submitted by a recruiter for a position, may determine that the candidate is acceptable and hire the candidate. However, the company may also determine that the candidate is a good candidate for another position within the company that may not have been posted, or may be created for the candidate. In this case, the company may propose a new bounty to the recruiter that submitted the candidate. If no pre-agreed bounty modification terms have been agreed upon, then preferably a modification of the bounty agreement is agreed to. The company may also propose a new job in the company for the candidate, and accept the candidate as an applicant for that position, or hire the candidate outright at a pre-determined bounty) for proposed new jobs. The bounty determined may be paid according to the terms agreed upon between the company, the recruiter and any third parties involved in the recruitment process.

In one variation of Step S406, a company may specify that a best candidate will be hired by a deadline, such that one of the recruiters will earn the bounty, and also to encourage candidates to be submitted before a deadline presented with the job listing. The company preferably evaluates the job candidate as being a good match for the position right before the hiring decision is made, i.e. at the deadline. However, the company may evaluate the currently submitted candidates at any time before the deadline and rank the candidates in order, or simply select the best candidate, display the rankings, and/or notify the other recruiters to keep looking for a better candidate. In one version, recruiters may agree to accept a reduced bounty, or pay a fee to view the ranking of their candidate and/or all other candidates for the position. Companies may end the candidate submission time early if an acceptable candidate is found, and this may cost a fee. The bounty may be held in escrow by a third party. Further, a company may specify that one recruiter from the pool of recruiters that submit candidate information will earn a bounty, or otherwise signify that the company is not recruiting for that position from other sources than the pool of recruiters that submit candidate information.

A further variation of Step S406 may include the creation and payment of a standing bounty for candidates, allowing the company to place a standing order for at least one skill or type of candidate that the company is always looking for (such as software engineers at Google). A company may accept any number of candidate submissions from recruiters for an indefinite time (or until later modified). Since the bounty is a standing bounty, the recruiter may submit any number of candidates, the number of candidate submissions per recruiter may be limited, or a specified number of un-hired candidate submissions may limit or reduce the frequency of submissions by the recruiter. The company may accept any number of candidate submissions from recruiters for an indefinite time. The recruiter may receive payments for each recruiter submitted candidate hired. These payments may be fixed amounts or fixed percentages of the company payment to a third party, or the amount of the payment may be variable, i.e. the payment from the company increases or decreases for each additional hired candidate submitted by a recruiter. Additionally, the standing order may appear as only a single job listing which may be re-listed either manually from a pool of positions (to clone) or automatically via a specification of the company. In one version, a recruiter may submit multiple candidates for a standing bounty or multiple candidates for different positions at a company. For each accepted candidate, the recruiter may earn a modified bounty, preferably a greater bounty. This modified bounty may be a higher fee for each additional candidate, or the modified bounty may be calculated synergistically (an extra 3% on all bounties for each additional candidate).

Another variation of step S406 may include soliciting feedback on a bounty. The feedback is preferably collected from at least one recruiter or preferred recruiters. The feedback preferably inquires about the size of the bounty, the challenges of the job placement, and/or any other important metrics of the bounty. The feedback solicitation is preferably performed with a drop down selection box on a web page, but may alternatively be a comment box, a telephone survey, a mail survey, or any other method of soliciting feedback. The feedback is preferably displayed to company so they may improve or modify the bounties. The feedback may also be displayed to other recruiters, to allow them to evaluate the company and/or bounty.

Step S408, which recites receiving information about a candidate for the available position of the company from the recruiter, functions to receive information about a candidate for the available position of the company from the recruiter and submitting the information about the candidate for the available position to the company. The information about the candidate can include any pertinent biographical or working history, including for example a resume, curriculum vitae, writing sample, salary requirements, salary history, employment history, employer references, background check information, professional or paraprofessional licenses, credit history, citizenship status, employment visa status, security clearances, and/or any additional information required for the available position. The information may include an attachment relating to a candidate, such as a writing sample, a coding sample, a transcript, or any other suitable attachment related to a candidate submission.

A further preferred variation of Step S408 preferably includes checking a database of previously submitted information about a candidate for the available position of the company and if information about the candidate for the available position of the company has not been previously submitted, then submitting the information about the candidate for the available position of the company to the company, otherwise informing the recruiter that the information about the candidate for the available position of the company has been previously submitted. Preferably, to prohibit the company from receiving information about any one candidate from multiple recruiters, which would hinder the efficiency and selection process of the company, a clearinghouse service prohibits multiple submissions of redundant information, which accelerates the efficiency and selection process of the company. The process of checking a database may include, for example, checking for a particular identification of the candidate. The identification may include, for example, the full name, the Social Security Number, the Driver's License Number, the home address, the email address, the phone number (home, work, or mobile), or any other appropriate identification of the candidate. The process of checking a database may alternatively include checking a hash function (a small digital “fingerprint”) of a portion of the submission, such as the resume of the candidate.

Step S410, which recites upon the selection by the company of a candidate for the available position, transmitting payment to the recruiter, functions to transmit a payment from the company to the recruiter. In the preferred embodiment, the company transmits a payment amount more than the bounty to a third party, and the third party transmits a payment for the amount of the bounty to the recruiter. Alternatively, a payment equal to the amount of the bounty is preferably transmitted to a third party, and the third party transmits a payment for the amount of less than the bounty to the recruiter. As noted above, the transfer may be performed by any party including any natural person or entity, as well as any of the parties described herein including the intermediary 10, shown in FIGS. 2 and 3. According to the variations described above therefore, the performer of the method can receive remuneration for its services depending upon the relationship between the bounty and the amounts payable/receivable from the recruiter/company, respectively.

The preferred embodiment of the method preferably includes setting the status of a recruiter S412. This step functions to allow an administrator to assign a particular status to a recruiter. These status assignments may include designating a recruiter as a preferred recruiter for the company, a blocked recruiter, an engaged recruiter, a contracted recruiter or any other suitable recruiter status. Designating a recruiter as a preferred recruiter functions to further streamline the selection process and to provide the company more control in its dealings with the plurality of recruiters. This step can be performed by any party designated above, preferably provided they have the necessary administrative privileges, including for example an intermediary as shown in FIGS. 2 and 3. Moreover, allowing the company to designate one or more preferred recruiters may lead to cost savings in the selection process, as one or more preferred recruiters may be preferred for their relatively low costs, high rate of performance, or both. Upon designation of the recruiter as a preferred recruiter for the company, allowing the preferred recruiter to access the contact information of the company. The administrator functions as another type of clearinghouse for the company to the extent that, at the company's discretion, it can authorize only a designated preferred recruiter to access its contact information. Those recruiters that are not designated as preferred recruiters will not have access to the company's contact information, and therefore will be less likely to submit candidate information to the company. Accordingly, the performer of this step aids in the streamlining and efficiency of the selection process by protecting the company from receiving unsolicited, non-preferred or otherwise undesirable submissions from a non-designated recruiter. Preferably, a preferred recruiter is highlighted or marked with a color or symbol such as a “P” or a star.

In one variation of Step S412, the company and the recruiter may designate the recruiter as an exclusive recruiter for an available position of a company. This step can include for example, causing the company to de-list substantially all active recruiters for an available position, such that a remaining recruiter becomes an exclusive recruiter for the available position. Alternatively, the step can include providing an agreement to be executed by the company and the recruiter, wherein the agreement specifies that only information about a candidate received from the exclusive recruiter can be submitted to the company. Alternatively, the agreement can authorize the third party or intermediary to block the submissions of all other recruiters to the company, the posting by the company of information regarding the available position to any other recruiters, or any combination thereof.

Another variation of Step S412 includes facilitating the mutual acceptance by both the company and the recruiter of the recruiter as an active recruiter for an available position of the company. The step of facilitating functions to streamline and accelerate the submission process by appropriately matching the company with a suitable recruiter for the active recruiter designation. The facilitation step can include for example, the aforementioned steps of establishing preferred, blocked, active, or de-listed recruiters as well as posting a performance history for each recruiter. Alternatively, the facilitation step can include providing a contract, agreement, discount, bonus or other incentive to designate the recruiter as an active recruiter. Alternatively, the facilitation step can include allowing the company to invite a recruiter from their list of preferred recruiters. As such, the facilitation step can further include the step of providing contact information for a recruiter, and providing contact information for any recruiter designated as a preferred recruiter to the company that designated the recruiter as such. The step may also include entering a contract with a recruiter (a contracted recruiter is preferably considered a preferred recruiter and preferably has substantially the same rights as a preferred recruiter, but a preferred recruiter is not necessarily a contracted recruiter). The contract may also dictate a modified bounty for a recruiter entering a contract with a company, which may ultimately be reflected as a discount to the company.

A recruiter may also be designated as a blocked recruiter for the company, preferably to protect the efficiency and timeliness of the submission process by limiting, at the designation of the company, the number and quality of recruiters that are submitting candidate information for any particular position for the company. This could be employed, for example, when a company determines that a particular recruiter has ignored the requirements for a particular available position, has submitted poor candidates, or has otherwise disappointed the company. Upon receiving information about a candidate for the available position of the company from the recruiter, checking a database of blocked recruiters for the company and if the recruiter is not a blocked recruiter for the company, then submitting the information about the candidate for the available position of the company to the company. If the recruiter is a blocked recruiter, then the alternative step includes informing the recruiter that the information about the candidate for the available position of the company has not been submitted. Functionally, the performer of these alternative steps further functions as a clearinghouse for the company, with the added benefits of automatically informing the recruiter that its services are not available to the company.

Step S412 may also include displaying information about the placement history for the active recruiters for an available position, to aid a co-worker of a company in distinguishing one or more active recruiters from each other, thereby allowing the company to more competitively select a proper recruiter and/or block any undesirable recruiters. Moreover, posting of the placement history functions to inform other recruiters about the success rate of their respective competition, thereby increasing each party's incentive to perform well in the submission step. In one version, the placement history includes one of the following measurements: number of submissions, number of selections of the candidates submitted to the recruiter, ratio of number of submissions to number of selections of the candidates submitted by the recruiter, an amount paid to the recruiter or any combination thereof. In another version, the placement history can include various qualitative judgments or rankings from companies for which the recruiter has performed in the past, or any combination of quantitative and qualitative factors or judgments indicative of the placement history of the recruiter. In yet another version, the placement history can include specific information about the successful placements of the recruiter in the past, such as information about the available position, the company, the elapsed time from the original posting to the submission of the first candidate or to the submission of the eventually selected candidate, the elapsed time from the posting to the selection of a candidate.

### 2.2 Second Enterprise Version

As shown in FIG. 5, a second method 500 of the preferred embodiment includes a series of steps to facilitate collaboration and communication between a plurality of recruiters while interacting with a company with an available position. The method preferably includes assigning administrative privileges to the plurality of recruiters S502, receiving information about the available position for the company from the company S504, receiving a bounty offer for the recruiter that submits information about a candidate that fills the available position of the company from the company S506, submitting the information about the candidate for the available position of the company to the company S508, and upon the selection by the company of a candidate for the available position, receiving payment from the company S510.

The second enterprise version of the preferred method of the invention, which is similar to the first enterprise version shown in FIG. 16, includes a marketplace at the enterprise level (between one or more companies with available positions and several recruiters working for the same recruiting firm). The second enterprise version includes a collection of recruiters (sometimes referred to as “enterprise recruiters”) for a particular recruiting firm. The second enterprise version preferably includes an administrator role that has special privileges and/or permissions, but this role (and the corresponding privileges and/or permissions) may alternatively be distributed to the enterprise recruiters.

Step S502, which recites assigning administrative privileges to the plurality of recruiters, functions to enable an administrator to add or delete recruiters within the recruiting firm, assign particular privileges and permissions (also called administrative privileges) to recruiters at a recruiting firm, such as assigning the task of filling available positions of the company to recruiters, assigning a suitable subset of the administrative privileges available to a recruiter, assigning permission to generate a report on a recruiter, assigning permission to generate a report on a company, assigning permission to access positions of a company, assigning permission to access contact information of a company, assigning permission to view the candidate hiring process, setting a range of bounty amounts for which a recruiter may submit candidates, and controlling the distribution of bounty payments received among all recruiters in the plurality of recruiters.

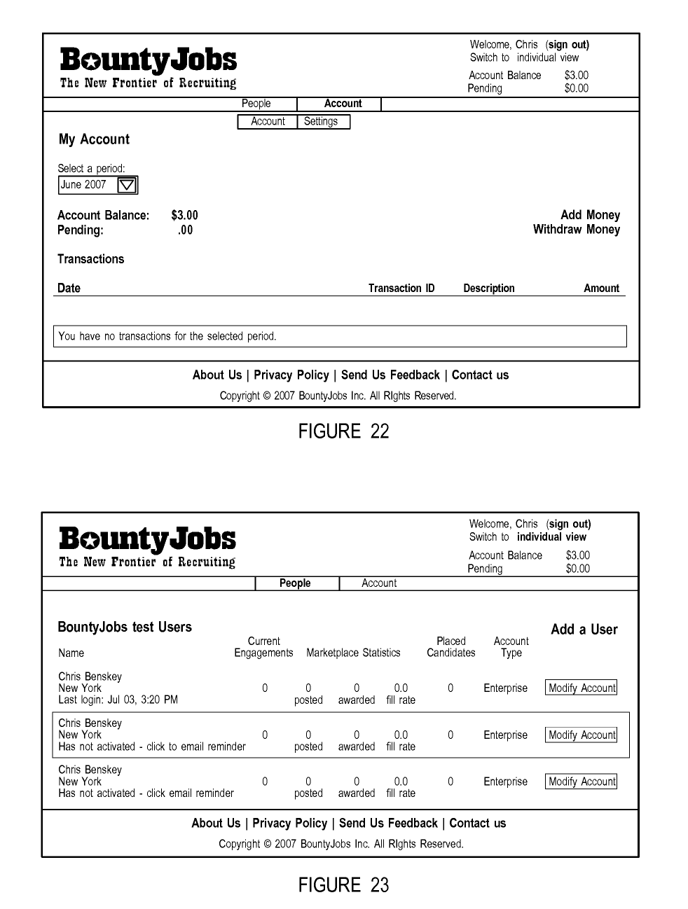

As shown in FIGS. 22 and 23, one of the privileges of the administrator includes adding and deleting enterprise recruiters within the recruiting firm and/or assigning particular privileges and/or permissions to the enterprise recruiters. This role may be reserved for a Human Resource Director (or equivalent) within the recruiting firm. Another privilege of the administrator includes receiving the bounty on behalf of an enterprise recruiter and, if necessary, re-assigning the bounty from one enterprise recruiter to another enterprise recruiter. This privilege may be useful to reward (or penalize) a particular enterprise recruiter, to more accurately capture the effort or value of an enterprise recruiter, or for any other suitable reason.

The statistics for the recruiting firm may be viewed, internally, on an enterprise recruiter level or an enterprise level. In a similar manner, the statistics for the recruiting firm may be viewed, externally from the corporate vantage point, on a enterprise recruiter level or an enterprise level. This may allow the recruiting firm to be regarded evaluated in a positive light (with strong statistics) even after a new recruiter (with weak statistics) has been recently added. In other words, the history in terms of the total available jobs and job placements of the recruiting firm may be captured and viewed, which would otherwise not be available in the individual version of the preferred method.

In the preferred embodiment, Step S502 includes setting administrative privileges for a news feed of recruiter activity. The news feed functions to capture the recent recruiting activity of recruiters and enable collaboration between at least one team of recruiters within the recruiting firm. The news feed is preferably visible to all recruiters working at a recruiting firm, but may alternatively be viewable by a subset of recruiters working at a recruiting firm if administrative privileges are set by the recruiting administrator (such as engineering job activities are only viewable by the engineering recruitment team). The recruiting administrator may also indicate which of their activities are visible to the company.

Like the first enterprise version, the second enterprise version may allow for special contract terms for the bounty transaction between the company and the recruiting firm. These special contract terms may be used, for example, when the recruiting firm wishes to use the second enterprise version with existing or previously contracted corporate clients. In this case, the distribution (or “cut”) of the bounty may be changed to reflect the responsibilities of the parties.

Step S504, which recites receiving information about the available position of the company from the company, functions to transfer information about the available position to the recruiter. The information about the available position can include any pertinent or requisite skills preferred or required for the available position as well as any background information about the company or the available position, as listed above. Preferably, the received jobs are sorted by a first sorting parameter such as industry, job title, job requirements, salary, bounty amount, region, or any other suitable sorting parameter. The received jobs sorted by the first sorting parameter are preferably further sorted by a second sorting parameter. The second sorting parameter is preferably based upon the most recent company login time. One objective of this second sorting parameter is to allow recruiters to determine how active a company is on the site, and possibly alter their strategy regarding that company. Another objective of the second sort is to provide an incentive for companies to use the site more frequently, as it provides a more visible placement of any or all of their listing at the top of any sorted results of any of the first sorting parameters.

In one preferred variation, recruiters may view the number of submissions for the available position. The number of submissions for the available position functions to inform the company and one or more recruiters as to the probability of a successful selection by the company of a candidate through the laws of supply and demand. As such, the step of posting the number of submissions for the available position further functions to inform the company and one or more recruiters as to the competitiveness of: (1) the company's position with regard to potential candidates, and (2) the one or more recruiters relative prospects of having one of its candidates selected by the company. If the number of submissions is large at a point in time, the company's competitive position is relatively increased while that of each individual recruiter is decreased. Conversely, if the number of submissions is small at a point in time, the company's competitive position is relatively decreased while that of each individual recruiter is increased.

Step S506, which recites receiving a bounty offer for the recruiter that submits information about a candidate that fills the available position of the company from the company, functions to display the bounty offered to the recruiter for filling an available position of the company.

Step S508, functions to submit the information about the candidate for the available position of the company to the company. The information about the candidate can include any pertinent biographical or working history, including for example a resume, curriculum vitae, writing sample, salary requirements, salary history, employment history, employer references, background check information, professional or paraprofessional licenses, credit history, citizenship status, employment visa status, security clearances, and/or any additional information required for the available position. The information may include an attachment relating to a candidate, such as a writing sample, a coding sample, a transcript, or any other suitable attachment related to a candidate submission.

In one variation Step S508 also includes the steps of checking a database of active recruiters for the company and if the recruiter is not an active recruiter for the company, then informing the recruiter that the information about the candidate for the available position of the company has not been submitted. Functionally, the performer of these alternative steps further functions as a clearinghouse for the company, with the added benefits of automatically informing the recruiter that its services are not available to the company.

In another variation Step S508 includes checking a database of active recruiters for the company and if the recruiter is not an active recruiter for the company, then receiving payment from the recruiter and submitting the information about the candidate for the available position of the company to the company. The monetary transaction functions as a disincentive for the non-active recruiter to submit candidates without properly considering the job position and the needs of the company. If faced with a charge to submit a candidate for a position, the non-active recruiter will likely limit or filter their submissions. Thus, the performer of this step aids in the streamlining and efficiency of the selection process by discouraging the submission of unsolicited, non-preferred or otherwise undesirable submissions from a non-active recruiter. The monetary transaction may be proportional, or otherwise related, to the size of the bounty of the available position.

Step S510, which recites, upon the selection by the company of a candidate for the available position, receiving payment from the company, functions to receive payment for recruiters after a candidate submitted by the recruiter is selected for the available position of the company. The payment from the company is preferably in an amount more than the bounty and transmitting an amount equal to the bounty to the recruiter. Alternatively, the payment from the company in an amount equal to the bounty and transmitting an amount less than the bounty to the recruiter. As noted above, the transfer may be performed by any party including any natural person or entity, as well as any of the parties described herein including the intermediary 10, shown in FIGS. 2 and 3. According to the variations described above therefore, the performer of the method can receive remuneration for its services depending upon the relationship between the bounty and the amounts payable/receivable from the recruiter/company, respectively.

Preferably, to avoid massive amounts of information overload for the recruiters, the postings of available positions can be restricted and/or the submissions may be restricted for recruiters based on the size of the bounty and based on the qualifications of the recruiter. For example, available positions with smaller bounties may be viewed by a larger portion (or all) of the recruiters, while available positions with larger bounties may be viewed by a smaller portion of the recruiters. In other words, the higher the bounty, the more restrictive (in terms of viewing an available position and/or a submitting information about a candidate). The restrictions may be based on one of the following measurements: number of submissions, number of selections of the candidates submitted to the recruiter, ratio of number of submissions to number of selections of the candidates submitted by the recruiter, an amount paid to the recruiter, candidate submission interview rate, recently filled positions, submission opened rate (the % of submissions by a recruiter that are opened), submission processed rate (the % of submissions not rejected or acted on within a time period (e.g. two weeks)) or any combination thereof. Alternatively, the restriction can be based on, for each recruiter, the number of designations as a blocked recruiter or a number of designations as a preferred recruiter, or any ratio or combination there of. Alternatively, the limited number can be based on various qualitative judgments or rankings from companies for which the recruiter has performed in the past, or any combination of quantitative and qualitative factors or judgments indicative of the limited number of active listings to which the recruiter should be entitled.

In one variation of Step S510, recruiters may view the current stage of the candidate hiring process for their submitted candidates. The company may post an update on the current stage of the hiring process, such as “contacting candidate”, “interviewing via telephone”, “interviewing in person”, “skills testing”, “reference checking”, “vacations”, “remove from public marketplace”, “negotiating”, “accepted”, “candidate declined offer”, “candidate not selected”, or any other suitable hiring process stage. This allows the recruiter to judge the likelihood of receiving the bounty for the candidate. It also allows employers to make a bounty private to only those recruiters that they want to invite. In another variation, recruiters may agree to accept a reduced bounty or pay a small fee to view the update on the current stage of the candidate hiring process. In yet another version, companies may pay a fee to avoid providing updates on the current stage of the hiring process. Similarly, S510 may also be adapted to include status updates on the payment of the bounty, particularly if there are any special conditions that may be applied before a bounty is paid, such as an applicant passing a drug test. May pay a bonus for a candidate reaching a certain stage of the hiring process (a consolation prize).

The preferred embodiment of the method preferably includes S512, which recites setting the status of a recruiter by the recruiter, functions to allow the recruiter to list as an active (or “engaged”) recruiter for the available position, or a contracted recruiter for the company. This step functions to allow a recruiter to signal increased interest in the company and the available position for the company, which in turn further functions to allow a recruiter to distinguish himself amongst other recruiters that may be passively interested in the submission for the available position. The step of listing as an active recruiter can be performed on or through a computer network such as that described above, thereby communicating the recruiter's listing to the company with the available position. The method may also include the step of allowing the recruiter to de-list a recruiter as an active recruiter for an available position. This step functions to permit a company to regulate the number and/or quality of recruiters that can submit themselves as an active recruiter for a particular available position. The de-listing can be performed through a computer network, such as through an Internet-based software operable through two or more networked computers. The de-listing can be in response to a past performance of a recruiter, a performance history of the recruiter, to decrease the number of active recruiters for the available position, or any other reason.

In one variation of Step S512, a list of active (or “pending”) engagements of a particular recruiter may be viewed by a recruiter evaluating a company, a company evaluating a recruiter, and/or a job candidate evaluating a recruiter and/or a company. The list of pending engagements may be filtered based on parameters such as number of jobs recruiting for, competitors, number of successful placements, number of jobs available, average response time, priority, or any other recruiting method. One of the purposes of the list is to provide some indicator of the responsiveness of the other party. For example a recruiter may review a list of the pending engagements of a company and determine the responsiveness/likelihood of getting a bounty is lower-than-desired if the company has a large number of jobs posted, a large number of preferred recruiters, or a large number of candidates pending for a particular job. However, a company may also evaluate how many other companies a recruiter was currently working for and use this information to decide whether or not to use the recruiter. For example, if a recruiter were a preferred recruiter for a number of well-known companies, then a company may view that recruiter as more successful and also engage them, even though they have a large number of pending engagements. An additional purpose of the list of pending engagements may be to allow companies to determine if a recruiter may have conflicts of interest, or be working with competitors.

Another variation of Step S512 includes facilitating the mutual acceptance by both the company and the recruiter of the recruiter as an active recruiter for an available position of the company. The step of facilitating functions to streamline and accelerate the submission process by appropriately matching the company with a suitable recruiter for the active recruiter designation. The facilitation step can include for example, the aforementioned steps of establishing preferred, blocked, active, or de-listed recruiters as well as posting a performance history for each recruiter. Alternatively, the facilitation step can include providing a contract, agreement, discount, bonus or other incentive to designate the recruiter as an active recruiter. Alternatively, the facilitation step can include allowing the company to invite a recruiter from their list of preferred recruiters. As such, the facilitation step can further include the step of providing contact information for a recruiter, and providing contact information for any recruiter designated as a preferred recruiter to the company that designated the recruiter as such. The step may also include entering a contract with a recruiter (a contracted recruiter is preferably considered a preferred recruiter and preferably has substantially the same rights as a preferred recruiter, but a preferred recruiter is not necessarily a contracted recruiter). The contract may also dictate a modified bounty for a recruiter entering a contract with a company, which may ultimately be reflected as a discount to the company.

In yet another variation of Step S512 the recruiter may be allowed to list as an active recruiter for a limited number of available positions. This step functions to increase the efficiency of the submission process by preventing recruiters from listing as active recruiters for an unsuitable number of available positions. To the extent that each recruiter is so limited, then each recruiter will have additional incentive, time and energy to most effectively submit information for more worthy candidates for the limited number of available positions. The limited number can be universally applied to every recruiter, or it can be individualized for each recruiter, or it can be determined according to a formula or combination of factors. For example, the limited number can be based on one of the following measurements: number of submissions, number of selections of the candidates submitted to the recruiter, ratio of number of submissions to number of selections of the candidates submitted by the recruiter, an amount paid to the recruiter or any combination thereof. Alternatively, the limited number can be based on, for each recruiter, the number of designations as a blocked recruiter or a number of designations as a preferred recruiter, or any ratio or combination there of. Alternatively, the limited number can be based on various qualitative judgments or rankings from companies for which the recruiter has performed in the past, or any combination of quantitative and qualitative factors or judgments indicative of the limited number of active listings to which the recruiter should be entitled.

Although omitted for conciseness, the preferred embodiments include every logical combination and permutation of the above variations, alternatives, and versions of the preferred embodiments (including the individual, the first enterprise version, and/or the second enterprise version).

As a person skilled in the art will recognize from the previous detailed description and from the figures and claims, modifications and changes can be made to the preferred embodiments of the invention without departing from the scope of this invention defined in the following claims.

We claim:

1. A system to facilitate engagement and communication between a company with an available position and at least one recruiter, comprising:
a server coupled to a computer network;
a user interface for co-workers at the company, wherein the user interface is coupled to the server over the computer network and allows a plurality of co-workers to post information to the server about an available position of the company, including a bounty, receive information from the server about candidates for the available position of the company, and select a candidate on the server for the available position; and
a user interface for recruiters, wherein the user interface is coupled to the server over the computer network and allows a plurality of recruiters receive information from the server about an available position of the company and submit information to the server about a candidate for the position of the company.

2. The system of claim 1, wherein the server transmits a portion of the bounty from the company to a recruiter upon receiving notification of the selection of a candidate for a position of the company.

3. The system of claim 1, wherein a user interface is a web-page viewed in a web-browser.

4. The system of claim 1, wherein a user interface is a rich internet application.

5. The system of claim 1, wherein the user interface for co-workers includes a news feed, wherein the news feed displays time stamped activities of the plurality of recruiters.

6. The system of claim 1, wherein the user interface for co-workers includes a news feed, wherein the news feed displays time stamped activities of the plurality of co-workers.

7. The system of claim 6, wherein one co-worker selected from the plurality of co-workers has administrative privileges over the news feed displayed for each co-worker.

8. A method to facilitate collaboration and communication between a plurality of co-workers of a company with an available position while interacting with a recruiter, the method comprising the steps of:
a) assigning administrative privileges to the plurality of co-workers;
b) posting information about the available position for the company;
c) posting a bounty for a recruiter that submits information about a candidate that fills the available position;
d) receiving information about a candidate for the available position of the company from the recruiter;
e) upon the selection by the company of a candidate for the available position, transmitting payment to the recruiter.

9. The method of claim 8, wherein the step of transmitting payment to the recruiter includes transmitting a payment to a third party which then transmits a portion of the payment to the recruiter.

10. The method of claim 8, wherein steps (b), (c), (d), and (e) are performed individually by co-workers with necessary administrative privileges to perform the individual step.

11. The method of claim 8, wherein step (a) is performed by a co-worker in the plurality of co-workers, wherein the co-worker is designated as a company administrator.

12. The method of claim 11, wherein a company administrator assigns administrative privileges to co-workers of the plurality of co-workers, wherein the administrative privileges are selected from the group consisting of: adding new co-workers, deleting co-workers, assigning administrative privileges to co-workers, assigning the task of filling available positions of the company to co-workers, adding new recruiters, blocking recruiters, engaging a recruiter, promoting a recruiter to a preferred recruiter, promoting a recruiter to an enterprise recruiter, and setting a range of bounty amounts for which a co-worker may authorize.

13. The method of claim 11, wherein step (a) is performed by a co-worker in the plurality of co-workers, wherein the administrative privileges are a subset of the administrative privileges available to the company administrator.

14. The method of claim 8, further comprising the step of updating a news feed upon actions of steps (a), (b), (c), (d), and (e).

15. The method of claim 14, wherein step (a) is performed by a co-worker in the plurality of co-workers, wherein the co-worker is designated as a company administrator, and includes assigning permission to access news feed updates.

16. The method of claim 8, wherein step (a) is performed by a co-worker in the plurality of co-workers, wherein the co-worker is designated as a company administrator, and includes one selected from the group consisting of: assigning permission to generate a report on a recruiter, assigning permission to generate a report on a co-worker, assigning permission to access positions of the company, assigning permission to generate a report on a candidate for a position of the company, and assigning permission to participate in the candidate hiring process.

17. A method to facilitate collaboration and communication between a plurality of recruiters while interacting with a company with an available position, the method comprising the steps of:
a) assigning administrative privileges to the plurality of recruiters;
b) receiving information about the available position of the company from the company;
c) receiving a bounty offer for the recruiter that submits information about a candidate that fills the available position of the company from the company;
d) submitting the information about the candidate for the available position of the company to the company; and
e) upon the selection by the company of a candidate for the available position, receiving payment from the company.

18. The method of claim 17, wherein the step of receiving payment from the company includes receiving a payment from a third party which transmits a portion of a payment from the company to the recruiter.

19. The method of claim 17, wherein steps (b), (c), (d), and (e) are performed individually by recruiters with necessary administrative privileges to perform the individual step.

20. The method of claim 17, wherein step (a) is performed by a recruiter in the plurality of recruiters, wherein the recruiter is designated as a recruiting administrator.

21. The method of claim 20, wherein a recruiting administrator assigns administrative privileges to recruiters of the plurality of recruiters, wherein the administrative privileges are selected from the group consisting of: adding new recruiters, deleting recruiters, assigning administrative privileges to recruiters, and assigning the task of filling available positions of the company to recruiters.

22. The method of claim 20, wherein step (a) is performed by a recruiter in the plurality of recruiters, wherein the administrative privileges are a subset of the administrative privileges available to the recruiting administrator.

23. The system of claim 20, wherein the recruiting administrator controls the distribution of bounty payments received among all recruiters in the plurality of recruiters.

24. The method of claim 17, further comprising the step of updating a news feed upon actions of steps (a), (b), (c), (d), and (e).

25. The method of claim 24, wherein step (a) is performed by a recruiter in the plurality of recruiters, and includes assigning permission to access news feed updates.

26. The method of claim 8, wherein step (a) is performed by a recruiter in the plurality of recruiters, wherein the recruiter is designated as a recruiting administrator, and includes one selected from the group consisting of: assigning permission to generate a report on a recruiter, assigning permission to generate a report on a company, assigning permission to access positions of a company, assigning permission to access contact information of a company, assigning permission to view the candidate hiring process, and setting a range of bounty amounts for which a recruiter may submit candidates.
